(19) United States
(12) Patent Application Publication
(10) Pub. No.: US 2012/0064216 A1
(43) Pub. Date: Mar. 15, 2012

(54) COOKING GRILL

(76) Inventor: Thomas Cullen, Ithaca, NY (US)

(21) Appl. No.: 13/230,044

(22) Filed: Sep. 12, 2011

Related U.S. Application Data
(60) Provisional application No. 61/381,950, filed on Sep. 11, 2010.

(51) Int. Cl. A47J 37/07; A23L 1/01

(52) U.S. Cl. 426/523; 126/25 R

(57) ABSTRACT

A cooking grill uses infrared radiant top-down heat from burning a solid carbonaceous fuel to cook food. The cooking grill includes a grill body having sidewalls, a fuel rack disposed substantially horizontally within the grill body and adapted to hold a carbonaceous solid fuel, and a food rack disposed substantially horizontally within the grill body below the fuel rack. A method of grilling a food item includes placing the food item in a food rack and inserting the food rack into a grill body in a substantially horizontal orientation, placing a solid carbonaceous fuel in a food rack in a substantially horizontal position above the food rack in the grill body, igniting the solid carbonaceous fuel, and removing the food rack from the grill body when the food is cooked.

### REFERENCE TO RELATED APPLICATIONS

This application claims one or more inventions which were disclosed in Provisional Application No. 61/381,950, filed Sep. 11, 2010, entitled “CHARCOAL GRILL”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of food grilling. More particularly, the invention pertains to methods and devices for charcoal grilling.

2. Description of Related Art

Outdoor barbecue grilling is acknowledged as one of the great American pastimes and is widely practiced throughout the year by millions of users. The existing grilling systems utilize a wire rack holding food above a basket or shelf containing charcoal briquettes or other types of burning fuel. Due to its popularity and extent of use, outdoor barbecue grilling has evolved throughout the years in attempts to address the common problems encountered while barbecue grilling.

Some problems of outdoor charcoal grilling have not been resolved. The disadvantages of the existing systems are fundamentally related to the uneven cooking temperatures, which are defined by (i) an uneven distance of the food from the burning fuel, (ii) an uneven distribution of the rising hot gaseous products of burning fuel for convective heating, (iii) flare-ups of dripping fat and oils, (iv) overheated grill racks supporting the food above the burning fuel, (v) a need to closely supervise the grilling process and frequently turn over and reposition food on the supporting wire rack and (vi) an uneven radiant heating of food by infrared heat as the distance to the food from the infrared radiation source is fundamentally non-uniform.

Specifically, in existing charcoal grills, as the charcoal briquettes burn unevenly and are arranged in an uneven pile on the supporting basket or tray, the heat distribution above the burning charcoal bed is highly non-uniform.

The convective movement of hot gases from the charcoal bed is directed upwards towards the food in peculiar pathways defined by the aerodynamics within the charcoal apparatus, by the temperature distribution, burning uniformity, and other parameters, resulting in a highly non-uniform and changing temperature distribution across the wire rack holding the food.

Once they come into contact with the hot charcoals, dripping fat and oils, for example those produced when grilling meats, produce undesirable flare-ups back toward the meat, resulting in highly non-uniform cooking and uneven burning of food and requiring constant supervision of the grill, relocation of the food, and extinguishing of the flare-ups. The resulting charring of the exterior of the meat frequently results in undesirable taste and may ultimately ruin a meal. In addition, the smoke caused by flare-ups also affects the taste of the meat. On the other hand, drips of non-combustible liquids from the cooked food, such liquid including water, juices, or sauces, result in the partial extinguishing of the burning charcoals, thus further contributing to the non-uniformity of heating via radiant heat or via convective heat.

The grill racks supporting the food above the burning fuel tend to overheat, as the areas of the racks not covered by the food are exposed to heat and conduct this excess heat towards the food. As a result, the parts of the food in contact with the grill wire racks are frequently burned or charred.

Further, the overall non-uniformity of the existing charcoal grills necessitates close supervision of the process, including frequently turning over and repositioning the food on the supporting wire rack. The disadvantages of the existing systems are further related to the resulting overcooked food, non-uniformly cooked food, partially undercooked food, and food which has a charred or burned taste. There are potential health hazards connected to burned and charred food, including carcinogenic substances formed by the burning of some meats. Further, the health hazards of non-uniformly cooked food having undercooked areas or pieces are also well-recognized.

Broiler systems utilizing gas or electricity as a heating medium are known and are used in household cooking, typically being part of the kitchen oven or range, or on an industrial scale, for example the well-known salamander broiler. Home broilers, however, cannot reach the temperatures required to achieve a surface sear, which locks in meat juices and results in a preferred taste. Industrial electrical or gas-fueled broilers produce high temperatures, and often have thermal output as high as 45,000 BTUs or more, but they are prohibitively expensive for the home cook to buy and operate. These systems that are designed to use electricity or gas as a heat source can not be converted to use a carbonaceous solid fuel source without completely re-designing or replacing the upper part of the system. The electrical or gas lines and equipment would need to be completely removed, and there would still not be enough space for the amount of charcoal that would be required. The natural gas or propane-fueled broilers are not suitable for outdoor barbecue cooking due to high costs, large gas consumption requirements, and the complex burner network needed to assure broiling uniformity.

Numerous attempts to improve the existing charcoal grill technology have failed to address the above fundamental problems of the existing systems utilizing a wire rack holding food above a basket or shelf containing charcoal briquettes or other types of burning fuel.

U.S. Pat. No. 2,510,856, entitled “PORTABLE CHARCOAL BROILER”, issued to Bettencourt on Jun. 6, 1950, discloses a charcoal broiling apparatus with two fuel grates which flank a holder including two vertical grill plates which hold the food in a substantially vertical orientation between the two fuel grates. This design prevents drippings from falling on the fuel but requires vertical orientation of the food being cooked and does not provide top-down radiant heating of the food.

U.S. Pat. No. 3,175,549, entitled “CHARCOAL BARBECUE BROILER FIREBOX”, issued to Bergsten on Mar. 30, 1965, discloses a firebox for use with a rotatable rotisserie. The firebox permits lateral adjustment of the distance between the burning charcoal and the rotisserie. This design prevents drippings from falling on the fuel but requires placing the food being cooked onto a rotisserie and does not provide top-down radiant heating of the food.

U.S. Pat. No. 6,230,700, entitled “CHARCOAL GRILL”, issued to Daniels et al. on May 15, 2001, discloses a charcoal grill with an off fire cooling system, an octagonal body shape, and a split fire system which doubles the coal heating surface area and doubles the coal heat output. The cooking system also has an air introduction system which circulates air throughout the interior of the grill to maintain an optimum cooking temperature in an attempt to eliminate grease fires and smoke associated with grease fire flare ups. The charcoal and food products are suspended while preventing grease from falling onto the burning charcoal coals. This grill provides only partial improvement for charcoal grilling, which are expensive, difficult to operate, and may require gas fuel or electric power which are not readily available outdoors.

U.S. Design Pat. No. D535,845, entitled “COMBINED BARBEQUE AND ROASTING SPIT”, issued to King on Jan. 30, 2007, discloses the ornamental design to a combined barbecue and roasting spit, where some of the fuel is held in baskets flanking a rotatable roasting spit for holding the food. This design prevents drippings from falling on the fuel but requires placing the food being cooked onto a spit and does not provide top-down radiant heating of the food.

Roasting boxes, such as the China grills offered by La Caja China (Medly, Fla., US) and the Cajun microwaves offered by The Crawfish Guy (New Orleans, La., US), use top-down heat, but these devices are designed for cooking large quantities of meat in the box. One of these roasting boxes can roast in the range of 70 to 100 pounds of meat at one time.

Other attempts to correct charcoal grilling problems include propane gas barbecue grills. However, such grills cannot duplicate the culinary satisfaction of an open fire barbecue grilling of a meal, nor can they achieve the high temperatures reached by the industrial broilers. Other limitations of these existing systems include slow heating, under heating, and cooking from the bottom up and thus include all the problems of convective heat sources, including uneven cooking, flare ups, and burning.

### SUMMARY OF THE INVENTION

A cooking grill uses infrared radiant top-down heat from burning a solid carbonaceous fuel to cook food. The cooking grill includes a grill body having sidewalls, a fuel rack disposed substantially horizontally within the grill body and adapted to hold a carbonaceous solid fuel, and a food rack disposed substantially horizontally within the grill body below the fuel rack. A method of grilling a food item includes placing the food item in a food rack and inserting the food rack into a grill body in a substantially horizontal orientation, placing a solid carbonaceous fuel in a food rack in a substantially horizontal position above the food rack in the grill body, igniting the solid carbonaceous fuel, and removing the food rack from the grill body when the food is cooked.

### BRIEF DESCRIPTION OF THE DRAWINGS

FIG. 1 shows a schematic perspective view of a cooking grill in an embodiment of the present invention.

FIG. 2 shows a schematic cross-sectional view of a cooking grill in an embodiment of the present invention.

FIG. 3 shows a schematic cross-sectional view of a fuel rack and a food rack in an embodiment of the present invention.

FIG. 4 shows a schematic cross-sectional view of another fuel rack in an embodiment of the present invention.

### DETAILED DESCRIPTION OF THE INVENTION

The cooking grill preferably relates to outdoor food preparation. The cooking grill is preferably a charcoal barbecue grill. The charcoal barbecue grill preferably cooks food products using heat generated by the combustion of a carbonaceous solid fuel such as wood, wood briquettes, charcoal, or similar fuels. The cooking grill preferably provides for fast, efficient, and highly uniform cooking, while decreasing burning and charring of the food that is associated with conventional barbecue grills. The cooking grill preferably cooks food products using radiant heat with the source of heat being located above the food being heated.

The cooking grill preferably has decreased flare-ups as well as faster cooking, and thus requires less supervision during operation, when cooking meats, poultry, fish, vegetables, and any other grillable food.

The cooking grill preferably generates a desirable thoroughly-cooked caramelized or seared outside layer on the food product, for example a meat product, while avoiding charring and burning of the food product due to uneven heating, flare-ups of the dripping fat and oil, and contact with overheated grill racks.

In some embodiments, the cooking grill includes a food rack positioned below a fuel rack holding carbonaceous fuel. In some embodiments, the food rack is a solid tray. In other embodiments, the food rack has grates, a mesh, or other design with through-holes or apertures. The fuel rack may be a basket, tray, grate, or mesh and serves to hold the burning charcoals. The distance between the bottom surface of the fuel rack and the food rack is preferably in the range of about 0.5 inch to about 10 inches, such as 1 inch, 2 inches, 3 inches, or similar.

In some embodiments, the food rack is slidably installed within the body of the grill on the rails mounted on the walls of the grill body. The food rack is preferably adapted to be pulled out from the grill body for positioning, repositioning, turning over, inspection, removal of food, and rack cleaning. There is preferably at least one opening in one of the sidewalls of the grill body for slidably inserting the food rack into the grill body and for slidably removing the food rack from the grill body.

In some embodiments, there are several levels of supports for the food rack so that the position of the food rack can be adjusted, with the distance of the food rack from the bottom of the fuel rack being varied as needed. In some embodiments the food rack supports are rails. The distance between the top of the food positioned on the food rack and the bottom surface of the fuel rack is preferably in the range of about 0.25 inches to about 10 inches, i.e. 0.5 inches, 1 inch, 2 inches, or 3 inches. This distance is adjustable by adjusting the position of the food rack on different rails mounted on the walls of the grill body. In other embodiments, there are only several levels of the supports for the fuel rack such that the location of the fuel rack is varied to vary the distance between the food rack and the bottom of the fuel rack. In other embodiments, there are multiple levels for both the fuel rack and the food rack such that the location of the fuel rack, the food rack, or the fuel rack and the food rack is varied to vary the distance between the food rack and the bottom of the fuel rack.

In some embodiments, the food rack is a mesh wire rack or grill permitting the fats and oils from the food to drip down. In other embodiments, the food rack is a tray with a solid surface. In some embodiments, the food rack includes a solid surface or a plate having apertures therein. In some embodiments, a drippings pan is disposed below the food rack within the grill body or outside the grill body, in which case the grill body has an opening at the bottom to enable the egress of dripping oil and fat.

In some embodiments, there is a conventional grilling rack installed above the fuel rack holding burning charcoals. In some embodiments, the food rack may additionally be positionable above the fuel rack, for traditional grilling using convective heat. In some embodiments, a lid covers the charcoal grill body from the top.

In some embodiments, the fuel rack has no apertures or openings in the bottom surface supporting the carbonaceous fuel, thus preventing the ash from falling down onto the food rack or onto the food being grilled. In other embodiments, a separate fuel tray having a solid surface with no apertures or openings is placed below the fuel rack in the grill.

In some embodiments, the fuel rack has openings or apertures enabling air ingress towards the burning fuel from the bottom surface of the fuel rack.

In some embodiments, the fuel rack is made of wire mesh or includes a grate having openings therein, thereby enabling air ingress to the burning fuel from the bottom surface of the fuel rack.

In some embodiments, the fuel rack has openings or apertures in the sidewall enabling air ingress, but no openings or apertures on the bottom surface of the fuel rack, thus preventing the ash from falling down onto the food rack.

In some embodiments, the bottom surface of the fuel rack has ribs or protrusions within the bottom surface, with these ribs having air ingress openings starting at the bottom surface of the fuel rack and terminating at the side walls of the ribs, thus permitting air ingress while preventing the ash from falling down onto the food positioned on the food rack.

In some embodiments, a fuel pan is disposed between the fuel rack and the food rack, positioned below the fuel rack but above the food rack. In this embodiment, the fuel pan catches the ash while enabling the radiant heat to pass through towards the food. The fuel pan is preferably metallic, more preferably a highly heat-conducting metal. The fuel pan may be solid or of a very fine mesh.

Referring to FIG. 1, a cooking grill 10 includes a grill body 12, a fuel rack 14 supported in the grill body 12, and a food rack 16 supported in the grill body 12 below the fuel rack 14. The fuel rack 14 has a substantially horizontal surface for holding the solid carbonaceous fuel in the cooking grill 10. The food rack 16 has a substantially horizontal surface for holding the food to be grilled in the cooking grill 10. The cooking grill 10 may also include a lid 18 covering the top of the grill body 12.

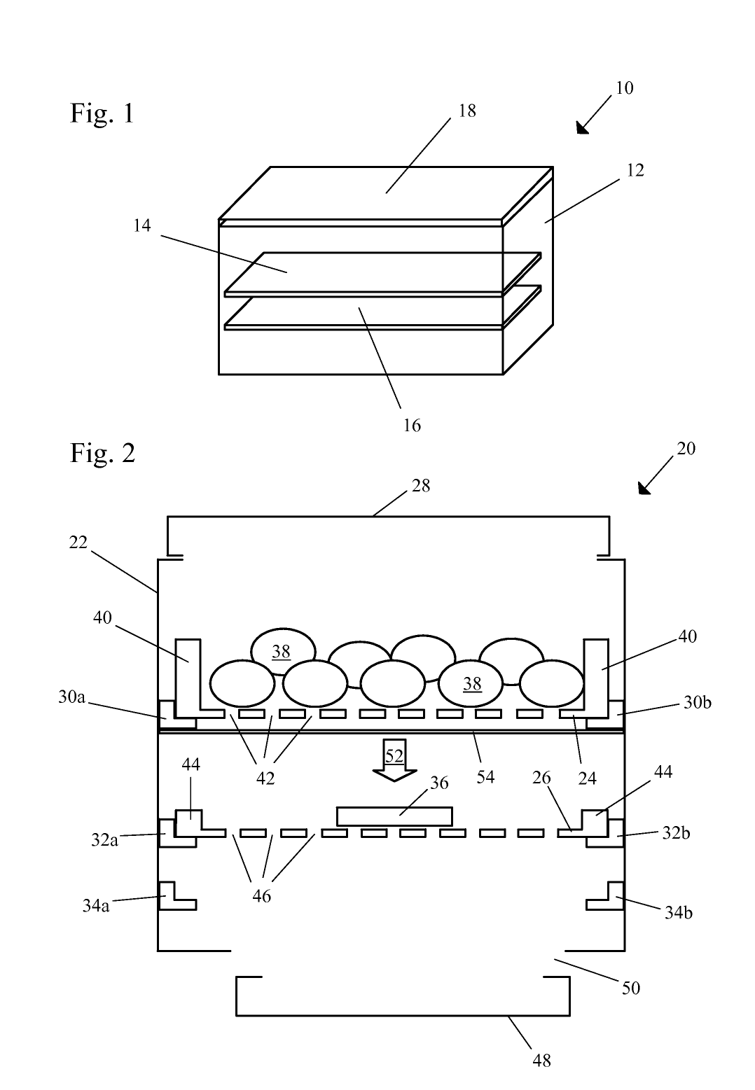

In the more detailed view of FIG. 2, the fuel rack 24 is supported by fuel rack rails 30a, 30b mounted within the grill body 22 of the cooking grill 20. The food rack 26 is supported by food rack rails 32a, 32b mounted within the grill body 22. The food rack 26 may be moved to a second set of food rack rails 34a, 34b to adjust the distance between the food 36 held by the food rack 26 and the fuel 38 held in the fuel rack 24. The fuel rack 24 includes a sidewall 40 to contain the fuel 38 and openings 42 on the bottom of the fuel rack 24. The food rack 26 includes a lip 44 around the edge and openings 46 on the bottom of the food rack 26. The cooking grill 20 also includes a lid 28 and a drippings pan 48 with an opening 50 between the bottom of the grill body 22 and the drippings pan 48 for egress of drippings. Radiant heat 52 from the burning fuel 38 cooks the food 36. A fuel pan 54 located between the fuel rack 24 and the food rack 26 prevents ash from the burnt fuel 38 from falling on the food rack 26 or the food 36.

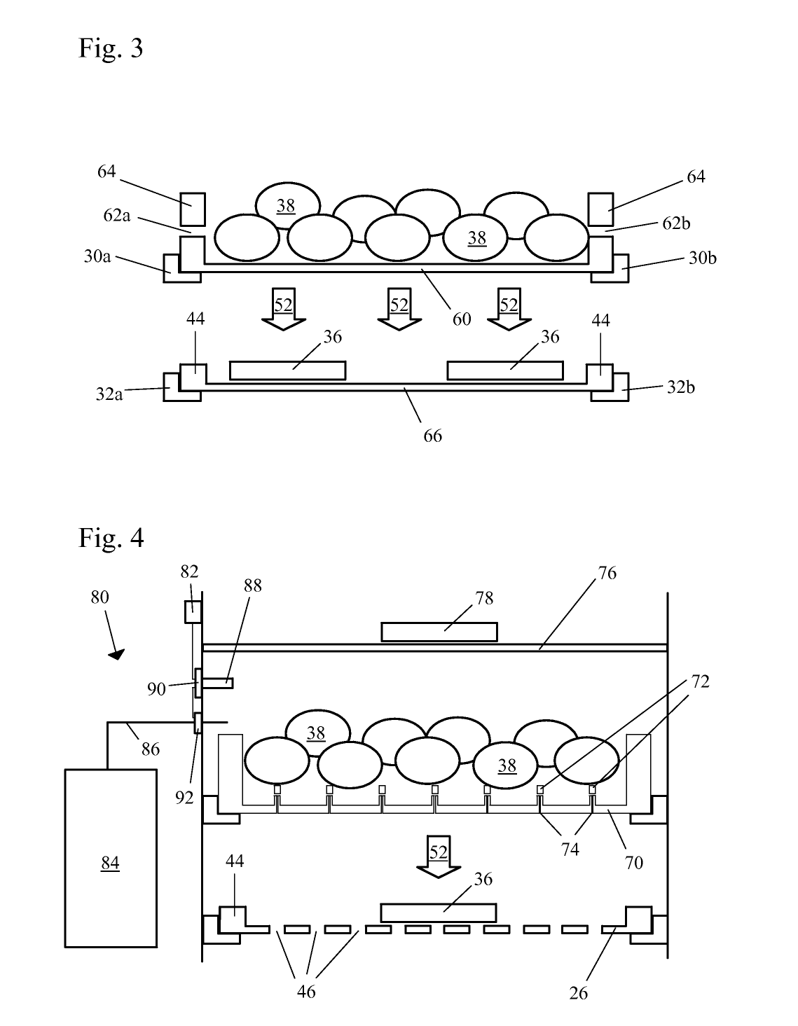

In an alternate embodiment shown in FIG. 3, both the fuel rack 60 and the food rack 66 have solid bottom surfaces. Openings 62a, 62b in the sidewall 64 of the fuel rack 60 permit ingress of air. In such embodiments, the fuel rack rails 30a, 30b and food rack rails 32a, 32b, 34a, 34b may include vertical openings to promote ingress of air.

In another alternative embodiment shown FIG. 4, the bottom surface of the fuel rack 70 has protrusions 72 within the bottom surface, with these protrusions 72 having air ingress openings 74 starting at the bottom surface of the fuel rack 70 and terminating at the side walls of the protrusions 72, thus permitting air ingress while preventing the ash from falling down onto the food 36 positioned on the food rack 26. A grilling rack 76, which may or may not include openings or slats, located above the fuel rack permits the grilling of food in a conventional manner with the heat source below the food 78, which may be done simultaneously or independently of grilling food below the fuel source.

In some embodiments, the carbonaceous fuel is ignited in a conventional way. In some embodiments, a liquid combustible, such as lighter fluid, is spread over the solid carbonaceous fuel and ignited. In other embodiments, a fast-burning solid, such as crumpled newspaper or paper, is mixed with or placed under the solid carbonaceous fuel and lit. The liquid combustible or the fast-burning solid provides sufficient heat for a sufficient amount of time to ignite the solid carbonaceous fuel.

In other embodiments, the cooking grill includes an automatic ignition system 80, as shown schematically in FIG. 4, such that the user only needs to put the solid carbonaceous fuel 38 into the fuel rack 70 and activate an ignition device 82 to ignite the solid carbonaceous fuel using an ignition fuel source 84. In some embodiments, the ignition fuel is a liquid or gaseous fuel, which may include, but is not limited to, charcoal lighter fluid, propane, butane, kerosene, liquefied petroleum (LP) gas, or gasoline, and an ignition source. Activation of the ignition device 82 causes the ignition fuel to be automatically supplied by a fuel line 86 to the area above the fuel rack 70 and automatically ignited by an ignition source 88. Activating the ignition device 82 preferably sends a signal to an activation controller 90, which controls the opening and closing of a valve 92 on the fuel line 86 and the activation of the ignition device 82. The supply of the ignition fuel is automatically cut off when the burning ignition fuel has supplied sufficient heat for a sufficient amount of time to ignite the solid carbonaceous fuel.

Although only certain combinations of features are shown in the drawings, other combinations of features are possible within the spirit of the present invention. An automatic ignition system may be used in any embodiment of the present invention. A grilling rack may be used in any embodiment of the present invention. Finally, any combination of the disclosed fuel rack and food rack designs may be used within the spirit of the present invention.

Advantageously, the radiant heat uniformity distribution from the bottom surface of the fuel rack towards the food positioned below the fuel rack on the food rack is very high. Because of higher uniformity, the food may be positioned very close to the fuel rack as the source of radiant heat, thereby accelerating the heat transfer and the cooking process without burning of the food, particularly without non-uniform cooking and partial burning of the food. Positioning of the food rack below the fuel rack preferably eliminates all main sources of non-uniform grilling, food burning, disadvantages associated with convective heating non-uniformity and flare-ups, and the need for close supervision of the grilling process.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A cooking grill comprising:
a grill body having sidewalls;
a fuel rack adapted to hold a carbonaceous solid fuel, the fuel rack disposed substantially horizontally within the grill body; and
a food rack disposed substantially horizontally within the grill body below the fuel rack.

2. The cooking grill of claim 1, wherein the food rack is slidably and removably supported within the grill body on a plurality of rails mounted on the sidewalls of the grill body.

3. The cooking grill of claim 2 further comprising at least two sets of rails in at least two different vertical locations in the grill body such that a distance between the food rack and the fuel rack is adjustable.

4. The cooking grill of claim 1, further comprising a lid adapted to cover a top of the grill body.

5. The cooking grill of claim 1, further comprising a grilling rack disposed substantially horizontally within the grill body above the fuel rack.

6. The cooking grill of claim 1, wherein the fuel rack has a plurality of apertures for ingress of air.

7. The cooking grill of claim 1, wherein the fuel rack comprises a plurality of protrusions having a plurality of apertures for ingress of air.

8. The cooking grill of claim 1 further comprising an automatic ignition system comprising:
an ignition device mounted on the grill body;
an ignition controller communicatively coupled to the ignition device;
a fuel line comprising a fuel conduit terminating in an area above the fuel rack; and
a valve on the fuel line communicatively coupled to the ignition controller.

9. A method of grilling a food item comprising the steps of:
a) placing the food item in a food rack and inserting the food rack into a grill body in a substantially horizontal orientation;
b) placing a solid carbonaceous fuel in a food rack in a substantially horizontal position above the food rack in the grill body;
c) igniting the solid carbonaceous fuel; and
d) removing the food rack from the grill body when the food is cooked.

10. The method of claim 9 further comprising the step of activating an automatic ignition system to ignite the solid carbonaceous fuel.
